(19) United States
(12) Patent Application Publication
(10) Pub. No.: US 2013/0110424 A1
(43) Pub. Date: May 2, 2013

(54) APPARATUS AND METHOD TO DETECT POWER

(71) Applicants: Roopesh Bhaskaran Nagathil, Atlanta, GA (US); Jitendra Kumar, Mableton, GA (US); Dattaraj Jagdish Rao, Virginia Beach, VA (US); David Lee Rogers, Marietta, GA (US); Difei Wang, Marietta, GA (US)

(72) Inventors: Roopesh Bhaskaran Nagathil, Atlanta, GA (US); Jitendra Kumar, Mableton, GA (US); Dattaraj Jagdish Rao, Virginia Beach, VA (US); David Lee Rogers, Marietta, GA (US); Difei Wang, Marietta, GA (US)

(73) Assignee: General Electric Company, Schenectady, NY (US)

(21) Appl. No.: 13/284,627

(22) Filed: Oct. 28, 2011

(51) Int. Cl. G06F 19/00

(52) U.S. Cl. 702/62

(57) ABSTRACT

A power meter includes a power detection unit to sense a level of consumed power in at least a portion of a building and to output sensed power level data, a timing unit to designate a predetermined period of time, and an analysis unit. The analysis unit receives the sensed power level data, determines whether the level of consumed power is abnormal by generating a representative value representative of the level of consumed power over the predetermined period of time, compares the representative value to a threshold value, and outputs an alert to a remote device when it is determined that the consumed power is abnormal based at least on the comparison of the representative value to the threshold value.

### BACKGROUND OF THE INVENTION

The subject matter disclosed herein relates to a power meter to detect power and a power detection system. In particular, power meters monitor power usage in structures connected to a power grid. However, customers often are unaware of abnormal power usage or the differences between peak and non-peak times that correspond to different rates for power usage.

### BRIEF DESCRIPTION OF THE INVENTION

According to one aspect of the invention, a method to detect power comprises detecting power consumed in at least a portion of a building over a plurality of predetermined periods of time; calculating a representative value of the power consumed during each predetermined period of time; comparing the representative value to a threshold value; determining whether the detected power consumed is abnormal based at least upon the comparison of the representative value to the threshold value; and generating an alert when it is determined that the consumed power is abnormal.

According to another aspect of the invention, a power meter comprises a power detection unit to sense a level of consumed power in at least a portion of a building and to output sensed power level data; and an analysis unit to receive the sensed power level data and to determine whether the level of consumed power is abnormal by generating a representative value representative of the level of consumed power over a predetermined period of time, comparing the representative value to a threshold value, and outputting an alert to a remote device when it is determined that the consumed power is abnormal based at least on the comparison of the representative value to the threshold value.

According to yet another aspect of the invention, a power detection system comprises a power meter including a power detection unit to sense a level of power consumption in at least a portion of a building over a predetermined period of time, and an analysis unit to generate a representative value based on the sensed level of power over the predetermined period of time, to compare the representative value to a threshold value, to determine that the level of power consumption is abnormal based at least upon the comparison of the representative value with the threshold value, and to generate an alert when it is determined that the level of power consumption is abnormal; and a remote device to receive from the power detection device the alert.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an illustration of a power providing system.

FIG. 2 is a block diagram of a power meter according to one embodiment.

FIG. 3 illustrates components of the power meter according to one embodiment.

FIG. 4 is a flow diagram of a method of analyzing power consumption and providing an alert according to one embodiment.

FIG. 5 is a flow diagram of a method of analyzing power consumption and providing an alert according to another embodiment.

FIG. 6 is a graph of detected power.

FIG. 7 is a graph of a normalization of the detected power.

FIG. 8 illustrates a handheld device displaying an alert.

The following detailed description explains embodiments of the invention, together with advantages and features, by way of example with reference to the drawings.

### DETAILED DESCRIPTION OF THE INVENTION

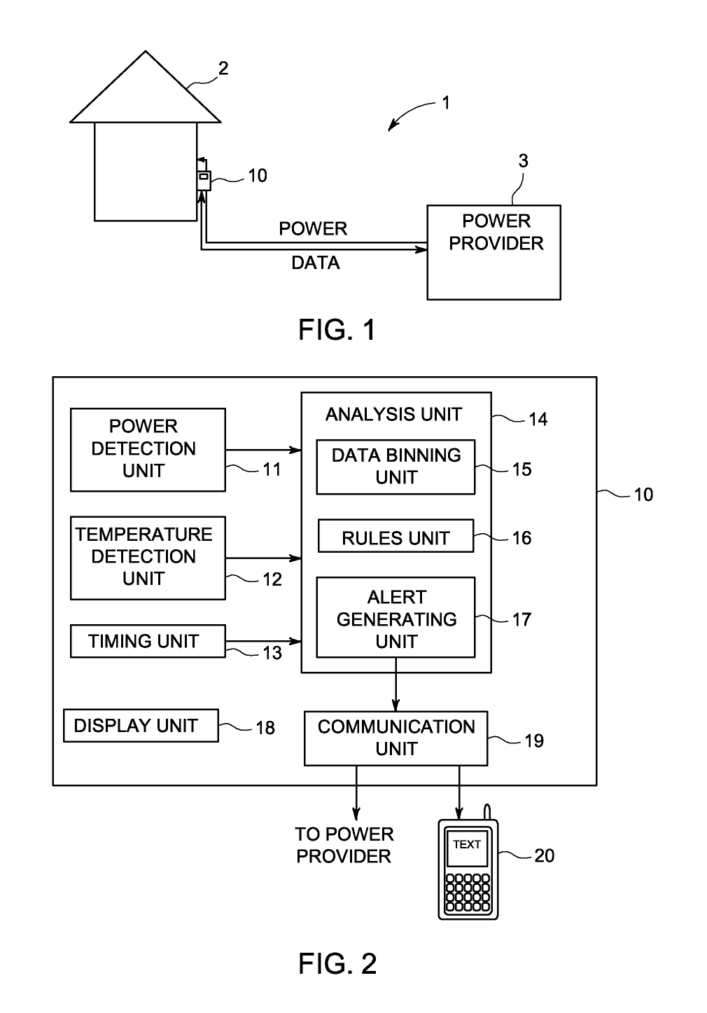

FIG. 1 illustrates components of a power providing system 1. The system includes a power meter 10 connected to a house 2. Power is supplied to the house from a power provider 3, and data is exchanged between the meter 10 and the power provider via a data connection. The power meter 10 detects a level of power consumed by the house 2 and transmits data regarding the consumed power to the power provider 3. The power provider 3 transmits data to the power meter 10 including billing data, control data, and other information.

In alternative embodiments, the building that receives the power from the power provider is one of a commercial building, such as an industrial facility or office building, an apartment building, an office or series of offices, an apartment, condo, or townhome, or a series of apartments, condos, or townhomes, etc.

FIG. 1 illustrates a data line connecting the meter 10 and the power provider 3. According to alternative embodiments, the data is transmitted to the power provider 3 via a wireless data connection, a fiber optic connection, or a cable connection. According to still other embodiments, the data is transmitted via the power line.

FIG. 2 illustrates an embodiment of a block diagram of a power meter 10. The power meter 10 includes a power detection unit 11, a temperature detection unit 12, and a timing unit 13. An analysis unit 14 receives power data, temperature data, and timing data from the power detection unit 11, the temperature detection unit 12, and the timing unit 13. The analysis unit 14 includes a data binning unit 15, a rules unit 16, and an alert generating unit 17. The data binning unit 15 organizes the power data and temperature data according to predetermined time periods based on the timing data provided by the timing unit 13. According to one embodiment, the time periods are hours, such as the twenty-four one-hour time periods between midnight of one day and midnight of the next day. Dividing the predetermined time periods into hours of a day aligns the predetermined time periods with time periods in which power providers divide time to calculate power usage charges. In alternative embodiments, the time periods are smaller intervals of time, such as fifteen-minute intervals, or larger periods of time, such as days.

The binned data is processed according to rules stored in the rules unit 16. Based on the results of the rules processing, an alert is generated by the alert generating unit 17. The alert generating unit 17 transmits alert data to a communication unit 19, which transmits the alert data to a power provider and to a remote device 20. The remote device 20 is a device operated by a user of the house 2. In the present embodiment, the remote device 20 is a smart phone. According to alternative embodiments, the remote device is a laptop, a personal computer, or any other handheld device capable of receiving personal text messages, rich-content messages, links, and other alerts.

The power meter 10 also includes a display unit 18 to display power data and to receive user input to control options of the power meter.

Both a user and a power provider access the power meter 10 to control display operations, to alter rules, and to set alert options. A user accesses the meter 10 directly via the display unit 18, such as a touch-screen display or LCD display having a separate keypad. The user selects and alters threshold values, as discussed below, to set rule options. The user also alters alert settings, such as a destination device.

In addition, both the user and the provider access the power meter 10 via the communication unit 19, which includes data communication modules, such as a cable data connection and an antenna to communicate wirelessly.

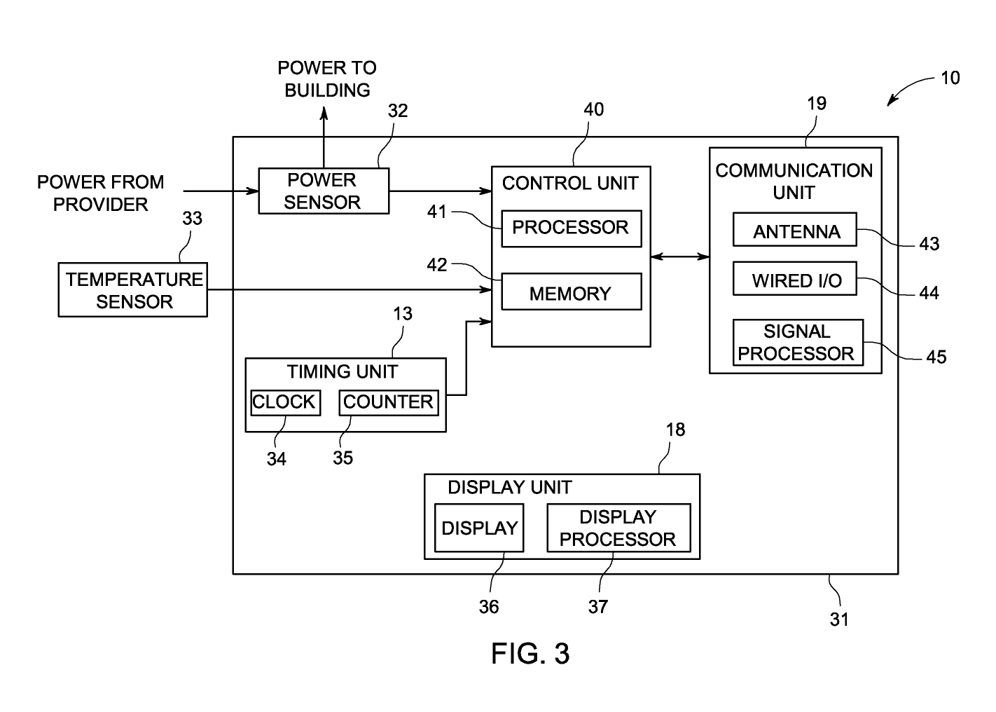

FIG. 3 illustrates an embodiment of a power meter 10 in which examples of physical components are provided.

The power meter 10 includes a case 31 and a control unit 40 including a processor 41 and memory 42. The memory 42 stores commands and data. The commands control the processor to perform operations, and the data is operated upon. For example, the data is stored, deleted, and altered, according to the operations performed by the processor 41.

The power detection unit 11 of FIG. 2 includes a power sensor 32 as illustrated in FIG. 3. A power line from the power provider to the building interacts with the power sensor 32 and the power sensor 32 provides sensed power data to the processor 41. The power detection unit 11 also includes the processor 41 and memory 42 to convert the sensor data into digital data that is stored in memory 42 and altered by the processor 41. For example, the sensor data may be received as analog data, and the processor 41 may convert the sensor data to a digital format for storage. According to an alternative embodiment, the power detection unit 11 is provided with a separate processing unit to process the received sensor data and to transmit the processed data to the control unit 40.

The temperature detection unit 12 of FIG. 2 includes a temperature sensor 33. The temperature sensor 33 senses temperature data and provides the sensed data to the control unit 40 for processing and storage. The temperature sensor 33 is located outside the house 2 to provide an outdoor temperature. The temperature detection unit 12 also includes the processor 41 and memory 42 to convert the sensor data into digital data that is stored in memory 42 and altered by the processor 41. According to an alternative embodiment, the temperature detection unit 12 is provided with a separate processing unit to process the received sensor data and to transmit the processed data to the control unit 40.

According to another alternative embodiment, the power meter 10 does not include the temperature detection unit 12, and instead temperature data is received from an external source, such as the power provider, via the communication unit 19. For example, temperature data from weather stations in a same geographical area as the house 2 may be used to provide temperature information to the processor 41.

The timing unit 13 includes a clock 34 and a counter 35. The clock 34 includes data including date and time data to the control unit 40. The counter 35 provides duration data to the control unit 40. According to an alternative embodiment, the processor 41 executes one or more programs from memory 42 to track date, time, and to track a duration. According to yet another alternative embodiment, date and time data is provided from an external source, such as from the power provider 3 via the communication unit 19. According to one example embodiment, the data and time data is stored in memory 42 and executed by the processor 41, and updated at predetermined intervals by an external source, such as by the power provider 3.

The display unit 18 includes a display 36 and a display processor 37. The display unit 18 receives data from the control unit 40 to display, processes the data, and displays the data on the display 36. According to an alternative embodiment, the processor 41 prepares the data for display and transmits the processed data directly to the display 36. According to various embodiments, the display 36 is any one of an LCD display, LED display, and a rotating dial.

The analysis unit 14 of FIG. 2 includes at least the processor 41, memory 42, and any additional supporting logic and circuitry. The data binning unit 15 includes data stored in memory 42 to divide power and temperature data into predetermined time intervals. According to one embodiment, power data from the power sensor 32 is stored in the memory 42. The processor 41 determines when the predetermined period of time has elapsed, and generates a representative value of all of the sensed power data from within the elapsed predetermined period of time. The processor 41 accesses a threshold value from memory 42. The result of the comparison of the threshold value and the representative value is one factor that is used to determine whether power usage during the predetermined period of time was abnormal.

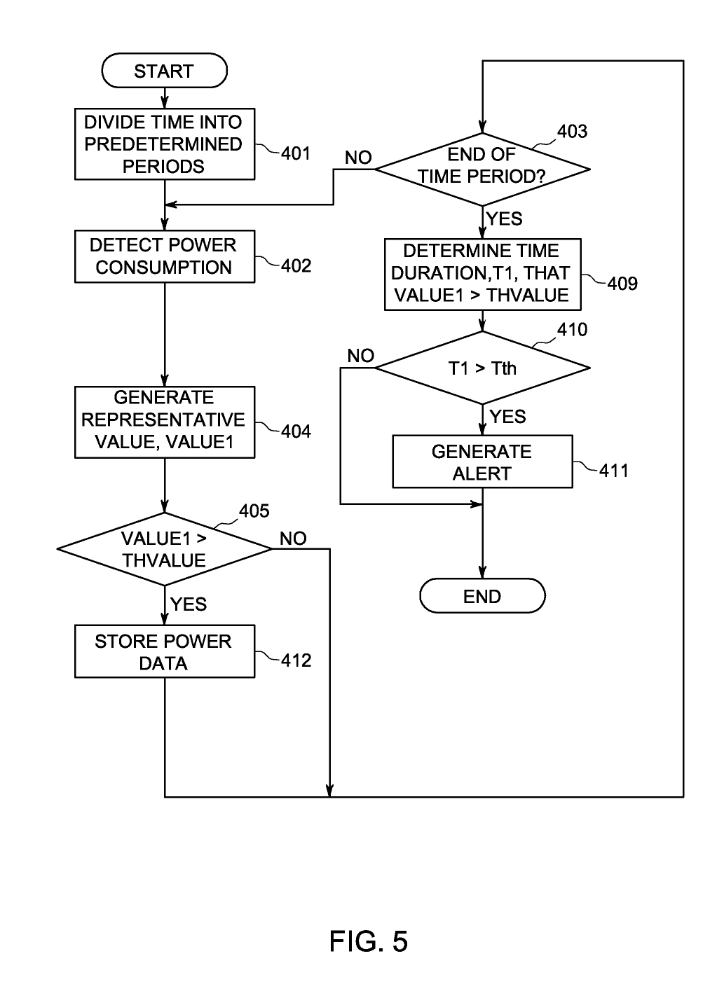

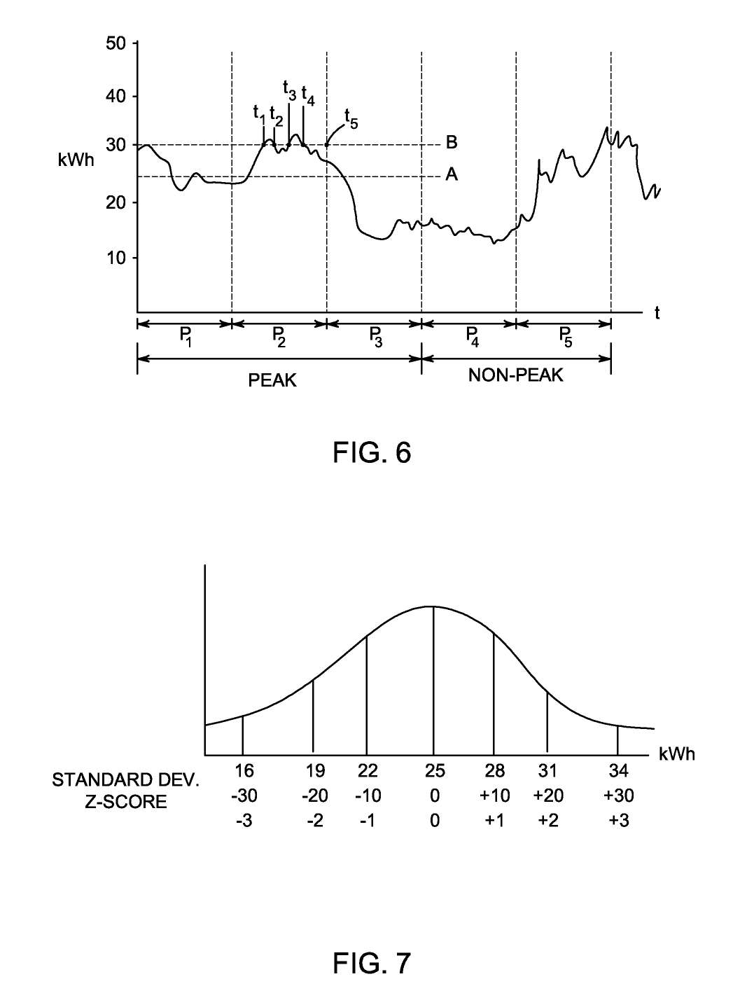

According to one embodiment, the representative value is a z-value, which is a unitless value that compares the detected power level to a standard deviation of a plurality of normalized plurality of power levels. The processor 41 analyzes the representative value from the predetermined period of time and calculates the z-value of the representative value when compared with a plurality of values. According to one embodiment, the plurality of values includes values from a predetermined number of previous time periods. According to alternative embodiments, the plurality of values is obtained from a same hour of each day for a predetermined number of previous days, or from a plurality of predetermined time periods of a same category as the elapsed predetermined time period. For example, if the elapsed predetermined time period is in a “peak” time, as determined by the power provider, then the plurality of the predetermined number of previous time periods is obtained from previous “peak” time periods and excludes “non-peak” or “off-peak” time periods. Similarly, if the predetermined time period is designated as “non-peak,” the representative value may be compared with a plurality of previous non-peak time periods to determine the z-score. Calculation of the z-score is described below in additional detail with reference to FIGS. 5 and 6.

According to another embodiment, instead of generating a representative value to represent the power generated during the entire elapsed predetermined time period, the processor 41 generates representative values of detected power in real-time. The processor 41 receives the power usage data, converts the power level data to a z-score, and compares the z-score to the threshold value. The threshold value varies among different predetermined periods of time. As discussed above, according to various embodiments, the z-score is determined by analyzing the detected power usage data together with power usage data from a predetermined number of previous time periods, including periods corresponding to a same hour of previous days and same categories of hours, such as “peak” and “non-peak” power usage hours, as determined by the power provider.

According to one embodiment, when the representative value is generated in real-time, a duration of time within the predetermined period of time is determined during which the z-scores of the detected power levels exceeded a threshold z-score. At the end of the predetermined time period, it is determined whether to generate an alert based on the detected duration of time within the predetermined period of time during which the z-scores of the detected power levels exceeded a threshold z-score. By waiting unit the end of the predetermined period of time to generate the alert, false alerts and alerts based on fleeting power spikes are reduced or eliminated.

According to one embodiment, another factor that is used to determine whether power usage during the predetermined period of time was abnormal is temperature. The processor 41 receives the temperature data from the temperature sensor 33 and compares the received temperature data to a predetermined temperature threshold. Temperature data from a previous predetermined time period is stored in memory 42. The processor 41 calculates a change in temperature between the previously-stored temperature data and the temperature data received from the temperature sensor 33 corresponding to the most recently-elapsed predetermined time period. The processor 41 compares the difference to a predetermined threshold to determine whether the change in temperature is greater than a predetermined change in temperature. The comparison of the sensed temperature data and the temperature threshold is another factor that is used to determine whether power usage during the predetermined period of time was abnormal.

Although an embodiment is disclosed in which the temperature threshold corresponds to a predetermined difference between two temperatures, according to an alternative embodiment, the temperature threshold corresponds to a target temperature, and the temperature data is compared to the target temperature.

According to various embodiments, the temperature data corresponds to one of a maximum temperature during the predetermined period of time, an average temperature, a mean temperature, a starting temperature, and an ending temperature during the predetermined period of time.

According to one disclosed embodiment, when the processor 41 determines that the representative value is greater than the threshold value, the processor determines a duration of time within the elapsed predetermined period of time that the sensed power level exceeded a power level corresponding to the threshold value. The determined duration is compared with a predetermined threshold duration stored in memory 42. The result of the comparison between the determined duration and the threshold duration is another factor that is used to determine whether a sensed power usage during the predetermined period of time was abnormal.

Based on the power, temperature, and time durations, the processor 41 determines whether to generate an alert. The determination whether to generate the alert occurs at the end of the predetermined period of time based on data collected during the entire predetermined period of time. A program is stored in memory 42 that generates a text or email and inserts into the text or email data regarding the sensed power usage. The processor 41 transmits the alert to the communication unit 19 to transmit to an external or remote device 20.

The communication unit 19 includes a circuit or structure to transmit a signal to a remote device 20. According to a disclosed embodiment, the circuit or structure includes at least one of an antenna 43 and a wired input/output port 44. Embodiments of a wired input/output port 44 include a USB port, a copper cable, a telephone cable, an Ethernet cable, and a fiber optic cable. The communication unit 19 further includes a signal processor 45 to process signals transmitted to and from the power meter 10. The signal processor 45 receives the alert from the processor 41 and processes the signal to be transmitted via at least one of the antenna 43 and the wired input/output 44.

According to an alternative embodiment, the power meter 10 transmits data to and from the power provider over the power line.

According to one embodiment, alert data is transmitted to the power provider, which in turn transmits the alert data to a remote device, such as a handheld device of a user associated with the power meter 10.

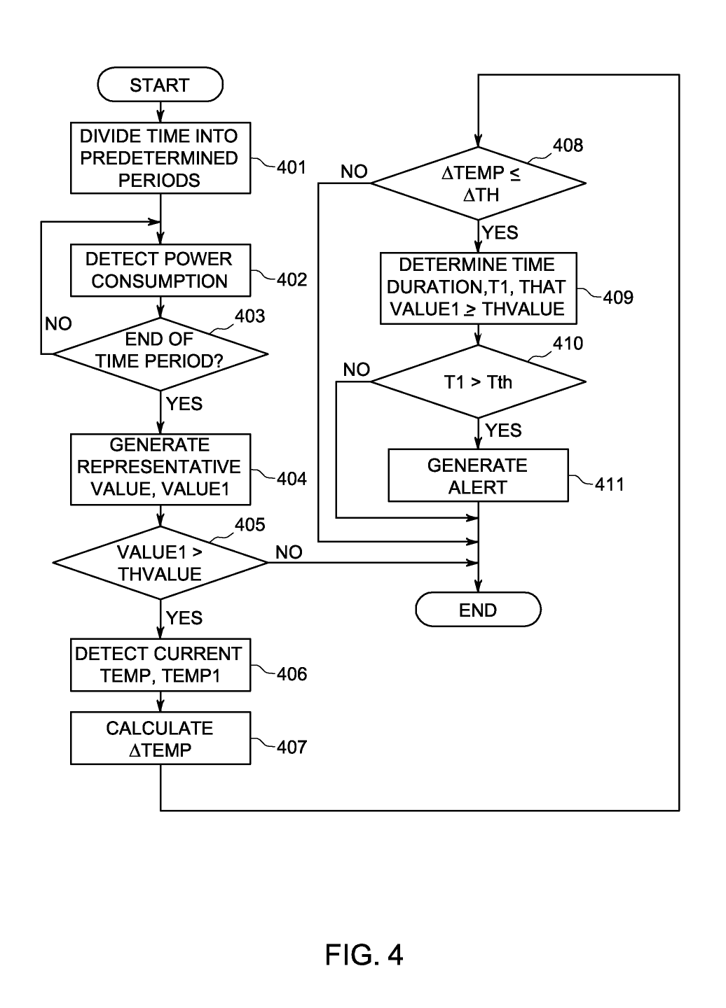

FIG. 4 illustrates a method of sensing power and providing an alert.

In operation 401, a span of time is divided into a plurality of predetermined periods of time. According to one embodiment, each day is divided into twenty-four one-hour periods of time. In operation 402, power consumed by at least a portion of a building is detected.

In operation 403, it is determined whether an end of a predetermined period of time has been reached. If not, power is continually detected in operation 402, and the detected power levels are stored. If the end of the period of time has been reached, the process continues to operation 404.

According to one embodiment, in operation 404, once the predetermined period of time has elapsed, a representative value, Value1, is generated. The representative value, Value1, is a value representative of the power usage sensed during the entire elapsed predetermined period of time. According to various embodiments, the representative value, Value1, is representative of an average power value during the predetermined period of time, a mean power value during the predetermined period of time, and a power level measured at a particular point in time. According to one embodiment, the representative value is a z-value, or a measure of the sensed power value relative to a standard deviation from a mean value from among a plurality of power values. The plurality of power values are taken from power values of previous predetermined periods of time. According to various embodiments, the predetermined periods of time correspond to a same hour of a different day as the elapsed predetermined period of time, a same category of a period of time, such as a plurality of previous “peak” periods or “non-peak” periods, and a plurality of periods of time immediately preceding the elapsed period of time. For example, if the elapsed period of time corresponds to a Wednesday, between 3 PM and 4 PM, according to one embodiment, the plurality of periods of time corresponds to a plurality of previous Wednesdays, between 3 PM and 4 PM. According to another embodiment, the plurality of periods of time corresponds to a plurality of previous peak hours, such as weekdays between 9 AM and 5 PM.

According to one embodiment, an average of the power consumed during the predetermined period of time is calculated, and a z-score is generated to compare the calculated average power consumed to averages of previous periods of time.

According to an alternative embodiment, a z-score comparing the detected power level to previously detected power levels is continually generated in operation 404 as the consumed power is detected in operation 402, and no average of the power consumed during the predetermined period of time is generated.

FIG. 6 illustrates consumed power sensed over predetermined periods of time P1-P5, and FIG. 7 illustrates calculation of a z-score of a measured power level.

In FIG. 6, time periods P1, P2, and P3 correspond to “peak” hours 2-3 PM, 3-4 PM, and 4-5 PM. Time periods P4 and P5 correspond to “non-peak” hours 5-6 PM and 6-7 PM. The peak and non-peak hours are determined by a power provider based on times at which demand for power is high and low on a power grid. The power provider may charge more to a customer to supply power during a peak hour than a non-peak hour.

FIG. 7 illustrates a normal distribution of power consumed during a predetermined number of previous time periods, such as peak time periods. The mean power consumption is 25 kWh (illustrated by dashed line A in FIG. 6), and z-scores of +1, +2, and +3 correspond to power consumption levels of 28 kWh, 31 kWh, and 34 kWh, respectively. Assuming that the threshold value, THvalue, during peak hours is +2, if a representative value of the peak period P2 is greater than 31 kWh, a determination regarding abnormal power usage is initiated (e.g. temperature and duration factors are considered).

In FIG. 6, dashed line B represents the sensed power usage level of 31 kWh. The sensed power usage rises above the threshold at time t1, drops below the threshold at time t2, rises above the threshold at t3, and drops below the threshold at t4. The predetermined time period P2 ends at t5.

According to the above-described embodiment in which all of the measured power of a predetermined time period, e.g. P2, are represented by a representative value, the power consumption between approximately 24 kWh and 34 kWh are averaged to generate a z-score. The average power usage during period P2 is approximately 26 kWh, which corresponds to a z-score between +0 and +1. In operation 405, it is determined whether the representative value, Value1, is greater than the threshold value, THvalue. Since the z-score, or the representative value, Value1, of the power usage during the period P2 is less than the threshold value +2, or THvalue, no alert is generated, and no further analysis regarding temperature and duration is performed.

According to one embodiment, the mean power consumption values and corresponding z-scores during peak and non-peak times are determined by the power provider. For example, the power provider determines that the mean power level during a peak time is 25 kWh and the mean power level during a non-peak time is 30 kWh. The power provider may provide mean power usage levels for peak and non-peak times to attempt to influence users to consume relatively less power during peak times and relatively more power during non-peak times.

According to one embodiment, when it is determined in operation 405 that the representative value, Value1, is greater than the threshold value, THvalue, a current temperature, Temp1, is detected in operation 406. In operation 407, a change in temperature is detected between the current temperature, Temp1, and a previously-stored temperature, such as a temperature from a same hour of a previous day.

In operation 408, the change in temperature is compared with a threshold value, ΔTH. If it is determined that the change in temperature is less than or equal to a threshold value, ΔTH, no alert is generated. In particular, since higher temperatures lead to increased power usage, if the temperature has dropped with respect to a previous temperature by a predetermined degree, then an increase in power usage in the current time period would not correspond to “peak” power usage, and no alert needs to be generated. However, if it is determined in operation 408 that the temperature has not dropped by a predetermined amount from previous temperature, then the method proceeds to operation 409 to calculate a time duration based on the representative value, Value1.

According to an alternative embodiment, a sensed temperature is compared to a threshold temperature. If the detected temperature is less than the threshold temperature, no alert is generated.

According to yet another embodiment, the detected temperature is compared to a range of temperatures. The temperature range may be determined by the power provider according to power grid data corresponding to customer power usage in each range. For example, the power provider may determined that if a temperature is above a first threshold or below a second threshold lower than the first threshold, then the process of determining whether to issue an alert continues.

In operation 409, a time duration is measured corresponding to the duration T1 at which the detected power usage was greater than a power usage corresponding to the threshold value, THvalue. In other words, referring to FIG. 6, the time between points t1 and t2 is calculated, and the time between t3 and t4 is calculated. According to the present embodiment, the total time T1 that the detected power level is greater than the power level corresponding to the threshold value THvalue is calculated, and the total time T1 is compared to a threshold duration, Tth. Even if the power repeatedly exceeds the threshold value for only short periods of time, an alert will be generated in operation 411 if the total sum of the short periods of time within the predetermined period of time (e.g. P2) is greater than the threshold duration, Tth. However, according to alternative embodiments, each separate time duration is compared to the threshold duration, Tth, and the alert is only generated in operation 411 if any one of the separate time durations exceeds T.

For example, with reference to FIG. 6, according to one embodiment, the sum of durations, t1-t2 and t3-t4, is compared to the threshold value Tth. However, according to another embodiment, the duration t1-t2 is compared to Tth, and then the duration t3-t4 is compared to Tth.

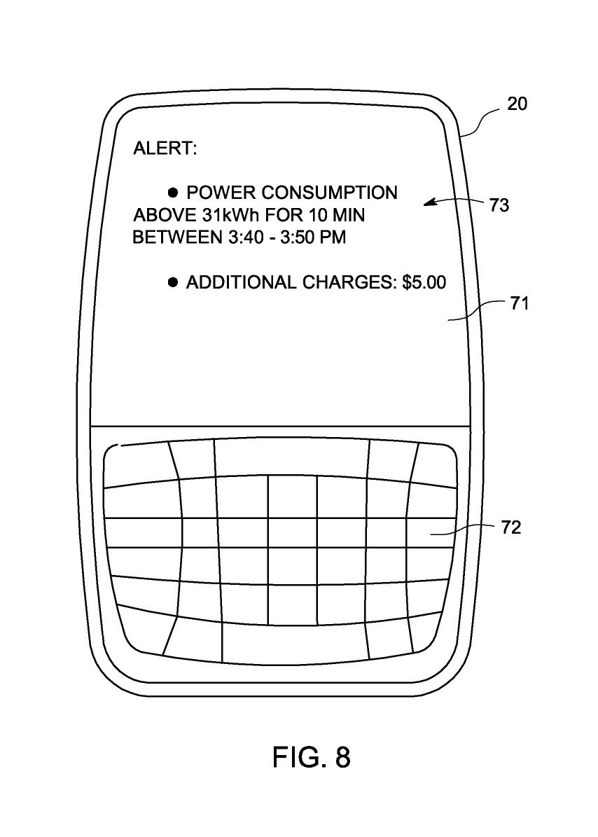

In operation 411, an alert is generated. The alert includes a text or email message including power consumption data. FIG. 8 illustrates an example of an alert provided to a smart phone. In FIG. 8, the smart phone 20 includes a screen 71 and keypad 72. An alert 73 is displayed on the screen 71, providing data to the user regarding a magnitude and duration of power usage that exceeded a predetermined power level. In addition, the alert 73 includes data regarding a monetary cost of the abnormal power usage.

FIG. 5 illustrates a method of detecting consumed power and generating an alert according to an alternative embodiment.

In FIG. 4, power is detected and stored in operation 402, and an average value of all of the detected power usage is used to generate a representative value in operation 404 after the end of the predetermined period of time is detected in operation 403. In contrast, FIG. 5 illustrates a method in which a representative value, Value1, is generated in operation 404 for each separate power measurement.

In particular, in operation 301, a predetermined period of time is set, such as an hour. Then, power usage is detected in operation 402. In operation 404, a representative value, Value1, is generated for each power measurement within the predetermined period of time as the predetermined period of time elapses. According to the present embodiment, the representative value, Value1, is a z-score of the measured power usage value compared with prior power usage values.

Each representative value, Value1, is compared to a threshold value, THvalue in operation 405. As illustrated in FIGS. 6 and 7, according to the present embodiment, the threshold value, THvalue, is a z-score of +2, which corresponds to a power usage level of 31 kWh. In FIG. 6, the power usage level rises above the threshold level at times t1 and t3. In other words, the power level at times t1 and t3 is determined to have a representative value, Value1, greater than the threshold value, THvalue. For example, the z-score of the power level detected at a time immediately after times t1 and t3 is greater than the +2 threshold value, THvalue.

If it is determined that the representative value, Value1, is greater than the threshold value, THvalue, the power data is stored in operation 412. According to the present embodiment, the power data includes the measured power usage level. After the representative value, Value1, is compared to the threshold value, THvalue, in operation 405, and after the power data is stored in operation 412, it is determined in operation 403 whether the end of the predetermined time period is detected. If the end of the predetermined period of time is detected in operation 403, then, in operation 409, the stored data from the predetermined period of time is analyzed regarding the duration of time T1 that the representative value, Value1, exceeded the threshold value, THvalue. As discussed above with respect to FIG. 4, if the duration T1 exceeds a threshold duration Tth, an alert is generated in operation 411.

According to the embodiment illustrated in FIG. 5, a representative value is generated in real-time in operation 404 instead of after a predetermined period of time has elapsed. The values of power usage detected during the entire period of time P2 are not averaged or adjusted. Instead, as each power level is detected in operation 402, the representative value, Value1, is calculated in real-time.

However, even though the representative values are generated in real-time, false alerts are avoided, because a determination of whether to generate the alert is made only after the predetermined period of time has elapsed, and a duration of high power consumption is determined to be above a threshold duration. Thus, in each predetermined period of time, it is determined whether an abnormal power usage occurred by determining if a high power usage occurred for at least a predetermined duration within the predetermined period of time.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method to detect power, comprising:
detecting power consumed in at least a portion of a building over a plurality of predetermined periods of time;
calculating a representative value of the power consumed during each of the plurality of predetermined periods of time;
comparing the representative value to a threshold value;
determining whether the detected power consumed is abnormal based at least upon the comparison of the representative value to the threshold value; and
generating an alert when it is determined that the power consumed is abnormal.

2. The method of claim 1, wherein each of the plurality of predetermined periods of time is equal to each other of the plurality of predetermined periods of time.

3. The method of claim 2, wherein each of the plurality of predetermined periods of time corresponds to an hour, the hour being one of twenty-four equal increments of time between midnight of one day and midnight an immediately next day.

4. The method of claim 2, wherein the threshold value corresponding to one of the plurality of predetermined periods of time is different from the threshold value corresponding to at least another of the plurality of predetermined periods of time.

5. The method of claim 4, wherein the one of the plurality of predetermined periods of time corresponds to a “peak” power usage period, and the other of the plurality of predetermined periods of time corresponds to a “non-peak” power usage period.

6. The method of claim 1, wherein the representative value corresponding to each of the plurality of predetermined periods of time is a z-score of the power detected during each of the plurality of predetermined periods of time, respectively.

7. The method of claim 1, wherein determining whether the detected power consumed is abnormal further comprises:
detecting a temperature at a time corresponding to one of the plurality of predetermined periods of time in which it is determined that the power consumed is greater than the threshold value;
comparing the detected temperature with at least one threshold temperature to determine whether the detected power consumed is abnormal.

8. The method of claim 7, wherein the at least one threshold temperature is a previously stored temperature that corresponds to a temperature of a previous day.

9. The method of claim 1, wherein determining whether the detected power consumed is abnormal further comprises:
determining whether the threshold value is exceeded for a predetermined duration of time.

10. The method of claim 1, wherein generating the alert includes transmitting a message to a remote device, and
the remote device is one of a handheld computing device and a smart phone.

11. The method of claim 1, further comprising:
transmitting to a power provider at least one of the detected power consumed and the representative value; and
receiving from the power provider the threshold value.

12. The method of claim 1, wherein calculating the representative value of the power consumed during each predetermined period of time of the plurality of predetermined periods of time includes calculating the representative value of each detected power level during each predetermined period of time of the plurality of predetermined periods of time and storing a comparison result of each representative value with the threshold value.

13. The method of claim 12, further comprising:
determining that one of the plurality of predetermined periods of time has elapsed;
calculating a duration of time during the elapsed predetermined period of time that the representative value exceeded the threshold value; and
comparing the calculated duration to a threshold duration.

14. A power meter, comprising:
a power detection unit to sense a level of consumed power in at least a portion of a building and to output sensed power level data; and
an analysis unit to receive the sensed power level data and to determine whether the level of consumed power is abnormal by generating a representative value representative of the level of consumed power over a predetermined period of time, comparing the representative value to a threshold value, and outputting an alert to a remote device when it is determined that the consumed power is abnormal based at least on the comparison of the representative value to the threshold value.

15. The power meter of claim 14, wherein the representative value is a weighted value to represent each different level of consumed power sensed over a course of the predetermined period of time.

16. The power meter of claim 15, wherein the representative value corresponding to the predetermined period of time is a z-score of the sensed level of consumed power during the course of the predetermined period of time.

17. The power meter of claim 14, wherein the predetermined period of time includes a plurality of predetermined periods of time,
the threshold value includes a plurality of threshold values corresponding to the plurality of predetermined periods of time, respectively, and
at least one of the plurality of threshold values is different from at least another of the plurality of threshold values.

18. The power meter of claim 14, further comprising a temperature detection unit,
wherein the analysis unit receives temperature data from the temperature detection unit during the predetermined period of time and determines whether the consumed power is abnormal based at least upon a comparison of the received temperature data with a temperature threshold.

19. The power meter of claim 14, wherein the analysis unit determines a duration within the predetermined period of time that the sensed level of consumed power is greater than a threshold power level, and determines whether the consumed power is abnormal based at least upon a comparison of the duration with a predetermined threshold duration.

20. A power detection system, comprising:
a power meter including a power detection unit to sense a level of power consumption in at least a portion of a building over a predetermined period of time, and an analysis unit to generate a representative value based on the sensed level of power over the predetermined period of time, to compare the representative value to a threshold value, to determine that the level of power consumption is abnormal based at least upon the comparison of the representative value to the threshold value, and to generate an alert when it is determined that the level of power consumption is abnormal; and
a remote device to receive from the power detection unit the alert,
wherein the remote device is one of a handheld device, a tablet device, a laptop, and a personal computer associated with a user of the at least a portion of the building.
